(19) United States
(12) Patent Application Publication
(10) Pub. No.: US 2022/0328830 A1
(43) Pub. Date: Oct. 13, 2022

(54) Graphene Nanoribbons as Electrode Materials in Energy Storage Devices

(71) Applicant: NTHERMA CORPORATION, Fremont, CA (US)

(72) Inventor: Cattien V. Nguyen, Milpitas, CA (US)

(21) Appl. No.: 17/719,991

(22) Filed: Apr. 13, 2022

Related U.S. Application Data
(60) Provisional application No. 63/174,154, filed on Apr. 13, 2021.

(51) Int. Cl. H01M 4/583; H01M 10/0525; H01G 11/36; H01G 11/46; H01M 4/525; H01M 4/505; H01M 4/485; H01M 4/133; H01M 4/131

(52) U.S. Cl. CPC H01M 4/583; H01M 10/0525; H01G 11/36; H01G 11/46; H01M 4/525; H01M 4/505; H01M 4/485; H01M 4/133; H01M 4/131

(57) ABSTRACT

Provided herein are electrodes which include graphene nanoribbons of uniform length and greater than 90% purity. Also provided herein are energy storage devices, where the electrodes include graphene nanoribbons of uniform length and greater than 90% purity. The energy storage device may be, for example, a lithium-ion battery, a lithium-ion polymer battery, a solid-state battery or an ultracapacitor.

### FIELD

Provided herein are electrodes which include graphene nanoribbons of uniform length and greater than 90% purity. Also provided herein are energy storage devices, where the electrodes include graphene nanoribbons of uniform length and greater than 90% purity. The energy storage device may be, for example, a lithium-ion battery, a lithium-ion polymer battery, a solid-state battery or an ultracapacitor.

### BACKGROUND

Energy storage devices such as, for example, lithium-ion batteries, lithium-ion polymer batteries, solid state batteries and ultracapacitors are power sources for many modern appliances, such as, for example, computers, electric vehicles, cellular telephones, etc. The above energy storage devices typically include one or more electrodes.

Graphene nanoribbons (GNRs) are a single or a few layers of the well-known carbon allotrope graphitic carbon, which possess exceptional electrical and physical properties that may be useful in energy storage devices. GNRs, structurally, have a high aspect ratio with length being much longer than width or thickness

Previous investigations have demonstrated energy storage devices that have electrodes which include GNRs provide superior performance when compared to energy storage devices which include only conventional electrodes. However, energy storage device that have electrodes which include GNRs are expensive and the GNRs are of insufficient length and purity.

GNRs are typically prepared from carbon nanotubes (CNTs) by chemical unzipping and the quality of GNRs depends on the purity of the CNT starting materials. Recently, methods which convert CNTs to GNRs in good yield and high purity (Hirsch, Angew Chem. Int. Ed. 2009, 48, 2694) have been developed. However, the purity and uniformity of the GNRs produced from these CNTs is determined by the method of manufacture of the CNTs.

Current CNT manufacturing methods typically produce CNTs which include significant impurities such as, for example, metal catalysts and amorphous carbon. Purification steps are typically required after CNT synthesis to provide material which is not contaminated with significant amounts of metal catalysts and amorphous carbon. CNT purification steps require large and expensive chemical plants, which makes producing large quantities of CNTs of greater than 90% purity extremely costly. Furthermore, present CNT manufacturing methods produce CNTs with low structural uniformity (i.e., CNTs of variable lengths).

Accordingly, what is needed are electrodes which include GNRs of high purity and uniform length for use in energy storage devices which are inexpensively produced and are uniform length and high purity.

### SUMMARY

These and other needs are satisfied by providing, in one aspect, electrodes, which include graphene nanoribbons of uniform length and greater than 90% purity.

In another aspect, provided are electrochemical cells which incorporate one or two electrodes which include graphene nanoribbons of uniform length and greater than 90% purity.

In still another aspect, provided is a lithium-ion battery. The lithium-ion battery has a housing which includes one or two electrodes which include graphene nanoribbons of uniform length and greater than 90% purity, a liquid electrolyte disposed between an anode and a cathode and a separator between the cathode and anode.

In still another aspect, provided is a lithium-ion polymer battery. The lithium-ion polymer battery has a housing which includes one or two electrodes which include graphene nanoribbons of uniform length and greater than 90% purity, a polymer electrolyte disposed between an anode and a cathode and a separator between the cathode and anode.

In still another aspect, provided is a lithium-ion polymer battery. The lithium-ion polymer battery has a housing which includes one or two electrodes which include graphene nanoribbons of uniform length and greater than 90% purity, a polymer electrolyte disposed between an anode and a cathode and a separator between the cathode and anode.

In still another aspect, provided is a solid-state battery. The solid-state battery has a housing which includes one or two electrodes which include graphene nanoribbons of uniform length and greater than 90% purity and a solid electrolyte disposed between an anode and a cathode.

In still another aspect, provided is an ultracapacitor. The ultracapacitor has two collectors, which are in contact with one or two electrodes, which include graphene nanoribbons of uniform length and greater than 90% purity, a liquid electrolyte disposed between the electrodes and a separator between the current electrodes.

### BRIEF DESCRIPTION OF THE FIGURES

FIG. 1 illustrates an exemplary flowchart for synthesis of carbon nanotubes, which includes the steps of depositing catalyst on a substrate; forming carbon nanotubes on a substrate; separating carbon nanotubes from the substrates; and collecting carbon nanotubes of high purity and structural uniformity

FIG. 2 illustrates an exemplary flowchart for synthesis of carbon nanotubes, which includes the steps of forming carbon nanotubes on a substrate; separating carbon nanotubes from the substrates; and collecting carbon nanotubes of high purity and structural uniformity.

FIG. 3 illustrates an exemplary flowchart for continuous synthesis of carbon nanotubes, which includes the steps of continuously depositing catalyst on a constantly moving substrate; forming CNTs on the moving substrate; separating CNTs from the moving substrate; and collecting carbon nanotubes of high purity and structural uniformity.

FIG. 4 illustrates an exemplary flowchart for continuous synthesis of carbon nanotubes, which includes the steps of forming CNTs on the moving substrate containing metal substrate; separating CNTs from the moving substrate; and collecting carbon nanotubes of high purity and structural uniformity.

FIG. 5 schematically illustrates a device for the continuous synthesis of carbon nanotubes, which includes various modules sequentially disposed such as a transport module for advancing the substrate through the modules; a catalyst module; a nanotube synthesis module; a separation module; and a collection module.

FIG. 6 schematically illustrates a device with closed loop feeding of substrate for the continuous synthesis of carbon nanotubes which includes various modules sequentially disposed such as a transport module for advancing the substrate through the modules; a catalyst module; a nanotube synthesis module; a separation module; and a collection module.

FIG. 7 schematically illustrates an exemplary separation module.

FIG. 8 schematically illustrates a horizontal view of a rectangular quartz chamber that includes multiple substrates, which may be used in the nanotube synthesis module.

FIG. 9 illustrates a perspective view of a rectangular quartz chamber that includes multiple substrates, which may be used in the nanotube synthesis module.

FIG. 10 illustrates TGA results which show greater than 99.4% purity for MWCNTs produced by the methods and apparatus described herein.

FIG. 11 illustrates Raman spectra which shows that MWCNTs produced by the methods and apparatus described herein are highly crystalline when compared to industrial grade samples.

FIG. 12 illustrates Raman spectra, which shows that graphene nanoribbons produced by the methods described herein are crystalline when compared to industrial grade samples.

FIG. 13 illustrates TGA results, which show greater than 99% purity for graphene nanoribbons produced by the methods described herein.

FIG. 14 illustrates a SEM image of GNRs made by the procedures described herein.

FIG. 15 illustrates an electrochemical cell.

FIG. 16 illustrates a solid-state battery.

FIG. 17 illustrates an ultracapacitor.

FIG. 18 illustrates a SEM image of CNTs made by a standard fluidized bed reactor.

FIG. 19A illustrates a SEM image of CNTs made by the procedures described herein.

FIG. 19 B illustrates a SEM image of CNTs made by the procedures described herein

FIG. 20 illustrates a SEM image of a slurry of Si particles (20%) with graphite anode.

FIG. 21 illustrates a SEM image of a slurry of nickel manganese cobalt particles and 0.5% GNRs with graphite anode.

FIG. 22 illustrates a SEM image of a slurry of nickel manganese cobalt particles and 1.0% GNRs with graphite anode.

FIG. 23 illustrates the sheet resistance of 20% Si-Graphite electrode layers with different conductive additives.

FIG. 24 illustrates a SEM image of electrode layers of 20% Si-graphite with 0.5% GNRs.

FIG. 25 illustrates capacitance results in different electrode layer thickness when the electrode includes GNRs.

FIG. 26 illustrates capacitance results in different electrode layer thickness when the electrode does not include GNRs.

FIG. 27 illustrates capacitance versus layer thickness with and without the addition of GNRs.

### DETAILED DESCRIPTION

### Definitions

Unless defined otherwise, all technical and scientific terms used herein have the same meaning as is commonly understood by one of ordinary skill in the art to which this invention belongs. If there is a plurality of definitions for a term herein, those in this section prevail unless stated otherwise.

As used herein “carbon nanotubes” refer to allotropes of carbon with a cylindrical structure. Carbon nanotubes may have defects such as inclusion of C5 and/or C7 ring structures, such that the carbon nanotube is not straight, may have contain coiled structures and may contain randomly distributed defected sites in the C—C bonding arrangement. Carbon nanotubes may contain one or more concentric cylindrical layers. The term “carbon nanotubes” as used herein includes single walled carbon nanotubes, double walled carbon nanotubes multiwalled carbon nanotubes alone in purified form or as mixture thereof. In some embodiment, the carbon nanotubes are multi-walled. In other embodiments, the carbon nanotubes are single walled. In still other embodiments, the carbon nanotubes are double walled. In still other embodiments, the carbon nanotubes are a mixture of single walled and multi walled nanotubes. In still other embodiments, the carbon nanotubes are a mixture of single walled and double walled nanotubes. In still other embodiments, the carbon nanotubes are a mixture of double-walled and multi-walled nanotubes. In still other embodiments, the carbon nanotubes are a mixture of single-walled, double walled and multi walled nanotubes.

As used herein “multi-walled carbon nanotubes” refer to carbon nanotubes composed of multiple concentrically nested graphene sheets with interlayer distances like graphite.

As used herein “double walled carbon nanotubes” refer to carbon nanotubes with two concentrically nested graphene sheets

As used herein “single walled carbon nanotubes” refer to carbon nanotubes with a single cylindrical graphene layer.

As used herein “vertically aligned carbon nanotubes” refer to an array of carbon nanotubes deposited on a substrate wherein the structures of carbon nanotubes are physically aligned perpendicular to the substrate.

As used herein “catalysts” or “metal catalysts” refer to a metal or a combination of metals such as Fe, Ni, Co, Cu, Ag, Pt, Pd, Au, etc. that are used in the breakdown of hydrocarbon gases and aid in the formation of carbon nanotubes by chemical vapor deposition process.

As used herein “chemical vapor deposition” refers to plasma-enhanced chemical vapor deposition, thermal chemical vapor deposition, alcohol catalytic CVD, vapor phase growth, aerogel supported CVD and lase assisted CVD

As used herein “plasma-enhanced chemical vapor deposition” refers to the use of plasma (e.g., glow discharge) to transform a hydrocarbon gas mixture into excited species which deposit carbon nanotubes on a surface.

As used herein “thermal chemical vapor deposition” refers to the thermal decomposition of hydrocarbon vapor in the presence of a catalyst which may be used to deposit carbon nanotubes on a surface.

As used herein “physical vapor deposition” refers to vacuum deposition methods used to deposit thin films by condensation of a vaporized of desired film material onto film materials and includes techniques such as cathodic arc deposition, electron beam deposition, evaporative deposition, pulsed laser deposition and sputter deposition.

As used herein “forming carbon nanotubes” refers to any vapor deposition process, including the chemical and physical vapor deposition methods described herein, for forming carbon nanotubes on a substrate in a reaction chamber.

As used herein “ultracapacitors” include electrochemical capacitors, electrical double layer capacitors, and super capacitors.

Carbon nanotubes are relatively new materials with exceptional physical properties, such as superior current carrying capacity, high thermal conductivity, good mechanical strength and large surface area, which are advantageous in many applications. Carbon nanotubes possess exceptional thermal conductivity with a value as high as 3000 W/mK which is only lower than the thermal conductivity of diamond. Carbon nanotubes are mechanically strong, thermally stable above 400° C. under atmospheric conditions and have reversible mechanical flexibility particularly when vertically aligned. Accordingly, carbon nanotubes can mechanically conform to different surface morphologies because of this intrinsic flexibility. Additionally, carbon nanotubes have a low thermal expansion coefficient and retain flexibility in confined conditions under elevated temperatures.

Economically providing carbon nanotubes, in a controlled manner with practical and simple integration and/or packaging is essential for implementing many carbon nanotube technologies. Devices and methods which provide large quantities of carbon nanotubes of exceptional purity and uniform length are provided herein. The CNTs synthesized herein do not require costly post-synthesis purification.

Briefly the general feature of the method are as follows. First, the substrate is heated at high temperature. Then catalyst is then coated on the surface of the substrate at high temperature to provide nanoparticles of catalyst on the substrate, which serve as initiation site for CNT synthesis. CNTs are synthesized by supplying a carbon source to the catalyst. Accordingly, a mixture of carbon source and carrier gas is flowed into a chamber which included heated substrate coated with catalyst to provide substrate with attached CNTs. Finally, synthesized CNTs are extracted from the substrate and collected. Optionally, the substrate coated with catalyst is regenerated.

In some embodiments, the catalyst is deposited on the substrate by sputtering, evaporation, dip coating, print screening, electrospray, spray pyrolysis or ink jet printing. The catalyst may be then chemically etched or thermally annealed to induce catalyst particle nucleation. The choice of catalyst can lead to preferential growth of single walled CNTs over multi-walled CNTs.

In some embodiments, the catalyst is deposited on a substrate by immersing the substrate in a solution of the catalyst. In other embodiments, the concentration of the catalyst solution in aqueous or organic solvents water is between about 0.01% and about 20%. In still other embodiments, the concentration of the catalyst solution in aqueous or organic solvents water is between about 0.1% and about 10%. In still other embodiments, the concentration of the catalyst solution in aqueous or organic solvents water is between about 1% and about 5%.

The temperature of the chamber where CNTs are made should be a temperature lower than the melting temperature of substrate, lower than the decomposition temperate of the carbon source and higher than the decomposition temperature of the catalyst raw material. The temperature range for growing multi walled carbon nanotubes is between about 600° C. to about 900° C., while the temperature range for growing single walled CNTs is between about 700° C. to about 1100° C.

In some embodiments, CNTs are formed by chemical vapor deposition on a substrate containing metal catalysts for the growth of CNTs. It is important to note that continuous CNT formation on a constantly moving substrate allows the CNTs to have uniform lengths. Typical feedstocks include, but are not limited to, carbon monoxide, acetylene, alcohols, ethylene, methane, benzene, etc. Carrier gases are inert gases such as for example, argon, helium, or nitrogen, while hydrogen is a typical reducing gas. The composition of the gas mixture and duration of substrate exposure regulates the length of synthesized CNTs. Other methods known to those of skill in the art such as, for example, the physical vapor deposition methods described, supra, the method of Nikolaev et al., Chemical Physics Letter,1999, 105, 10249-10256 and nebulized spray pyrolysis (Rao et al., Chem. Eng. Sci. 59, 466, 2004) may be used in the methods and devices described herein. Conditions well known to those of skill in the art may be used to prepare carbon nanotubes using any of the methods above.

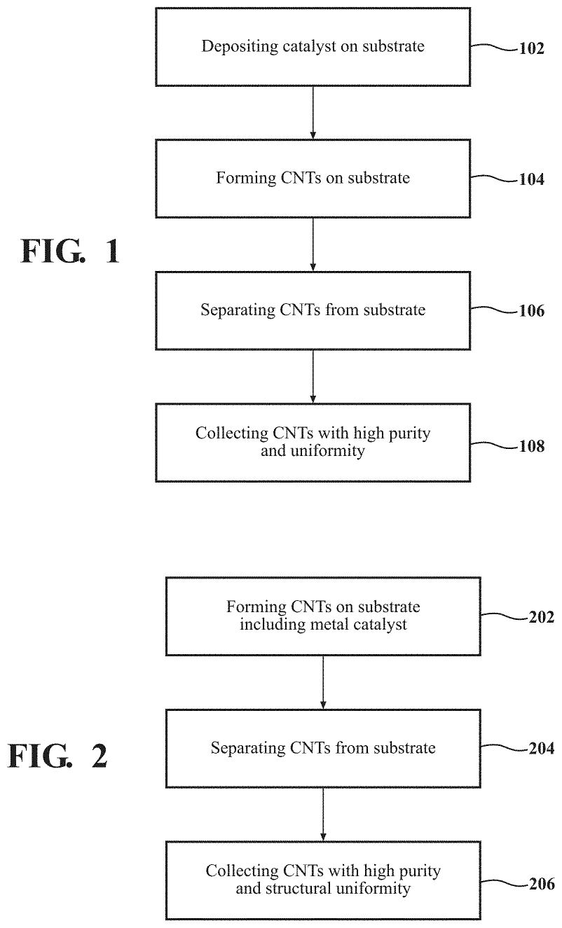

Referring now to FIG. 1, a method for synthesizing carbon nanotubes is provided. The method may be performed in discrete steps, as illustrated in FIG. 1. Those of skill in the art will appreciate that any combination of the steps can be performed continuously, if desired. A catalyst is deposited on a substrate at 102, carbon nanotubes are formed on the substrate at 104, carbon nanotubes are separated from the substrate at 106 and the carbon nanotubes are collected at 108.

Referring now to FIG. 2, another method for synthesizing carbon nanotubes is provided. The method may be performed in discrete steps, as illustrated in FIG. 2. Those of skill in the art will appreciate that any combination of the steps can be performed continuously, if desired. Carbon nanotubes are formed on a substrate, which already contains catalyst at 202, carbon nanotubes are separated from the substrate at 204 and the carbon nanotubes are collected at 206.

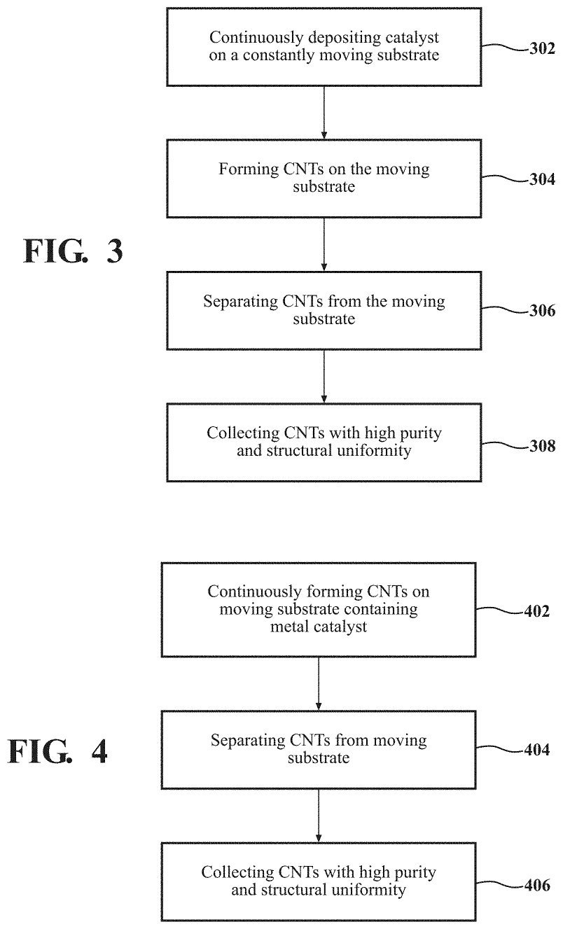

Referring now to FIG. 3, another method for synthesizing carbon nanotubes is provided. The method is performed continuously. A catalyst is continuously deposited on a moving substrate at 302, carbon nanotubes are continuously formed on the moving substrate at 304, carbon nanotubes are continuously separated from the substrate at 306 and the carbon nanotubes are continuously collected at 308. The substrate may be cycled through the steps described herein once or optionally, many times, such as, for example, more than 50 time, more than 1,000 time or more than 100,000 times.

Referring now to FIG. 4, another method for synthesizing carbon nanotubes is provided. The method is performed continuously as illustrated. Carbon nanotubes are continuously formed on the moving substrate which already contains catalyst at 402, carbon nanotubes are continuously separated from the substrate at 404 and the carbon nanotubes are continuously collected at 406. In some embodiments, the substrate is cycled through the deposition, forming and separating steps more than 50 times, more than 1,000 time or more than 100,000 times.

Deposition of CNTs on a moving substrate provides CNTs that are of both high purity and high length uniformity. Moreover, controlling process conditions enables the customization of CNT length. For example, variation of the rate of the moving substrate through the production process modifies CNT length; faster rates though the CNT deposition module produces CNT of shorter length, while slower rates will produce CNT of longer length.

In some embodiments, the substrate is completely covered by metal foil. In these embodiments, the substrate may be any material stable to conditions of catalyst deposition and CNT synthesis. Many such material are known to those of skill in the art and include, for example, carbon fibers, carbon foil, silicon, quartz, etc. In other embodiments, the substrate is a metal foil which can be continuously advanced through the various steps of the methods described herein.

In some embodiments, the thickness of the metal foil is greater than 10 μM. In other embodiments, the thickness of the metal foil is between about 10 μM and about 500 μM. In still other embodiments, the thickness of the metal foil is between about 500 μM and about 2000 μM.

In still other embodiments, the thickness of the metal foil is between about 0.05 μM and about 100 cm. In other embodiments, the thickness of the metal foil is between about 0.05 μM and about 100 cm. In other embodiments, the thickness of the metal foil is between about 0.05 mm and about 5 mm. In still other embodiments, the thickness of the metal foil is between about 0.1 mm and about 2.5 mm. In still other embodiments, the thickness of the metal foil is between about 0.5 mm and about 1.5 mm. In still other embodiments, the thickness of the metal foil is between about 1 mm and about 5 mm. In still other embodiments, the thickness of the metal foil is between about 0.05 mm and about 1 mm. In still other embodiments, the thickness of the metal foil is between about 0.05 mm and about 0.5 mm. In still other embodiments, the thickness of the metal foil is between about 0.5 mm and about 1 mm. In still other embodiments, the thickness of the metal foil is between about 1 mm and about 2.5 mm. In still other embodiments, the thickness of the metal foil is between about 2.5 mm and about 5 mm. In still other embodiments, the thickness of the metal foil is between about 100 μM and about 5 mm. In still other embodiments, the thickness of the metal foil is between about 10 μM and about 5 mm. In still other embodiments, the thickness of the metal foil is greater than 100 μM. In still other embodiments, the thickness of the metal foil is less than 100 μM.

In some embodiments, the metal foil includes iron, nickel, aluminum, cobalt, copper, chromium, gold, silver, platinum, palladium or combinations thereof. In other embodiments, the metal foil includes iron, nickel, cobalt, copper, gold or combinations thereof. In some embodiments, the metal foil may be coated with organometallocenes, such as, for example, ferrocene, cobaltocene or nickelocene.

In some embodiments, the metal foil is an alloy of two or more of iron, nickel, cobalt, copper, chromium, aluminum, gold or combinations thereof. In other embodiments, the metal foil is an alloy of two or more of iron, nickel, cobalt, copper, gold or combinations thereof.

In some embodiments, the metal foil is a high temperature metal alloy. In other embodiments, the metal foil is stainless steel. In still other embodiments, the metal foil is a high temperature metal alloy on which a catalyst is deposited for growing carbon nanotubes. In still other embodiments, the metal foil is stainless steel on which a catalyst is deposited for growing carbon nanotubes.

In some embodiments, the metal foil is a metal or combination of metals which are thermally stable at greater than 400° C. In other embodiments, the metal foil is a metal or combination of metals which are thermally stable at greater than 500° C., greater than 600° C., greater than 700° C. or greater than 1000° C. In some of the above embodiments, the combination of metals is stainless steel.

In some embodiments, the metal foil has a thickness of less than about 100 μM and a surface root mean square roughness of less than about 250 nm. In some embodiments, the metal foil has a thickness of greater than about 100 μM and a surface root mean square roughness of less than about 250 nm. In still other embodiments, the metal foil has a thickness of less than about 100 μM and a surface root mean square roughness of less than about 250 nm and includes iron, nickel, cobalt, copper, gold or combinations thereof. In still other embodiments, the metal foil has a thickness of greater than about 100 μM and a surface root mean square roughness of less than about 250 nm and includes iron, nickel, cobalt, copper, gold or combinations thereof. In still other embodiments, the metal foil has a thickness of less than about 100 μM and a surface root mean square roughness of less than about 250 nm and includes a catalyst film. In still other embodiments, the metal foil has a thickness of greater than about 100 μM and a surface root mean square roughness of less than about 250 nm and includes a catalyst film. In some of the above embodiments, the root mean square roughness is less than about 100 nm.

In some embodiments, the substrate continuously advances through the steps of the above methods at a rate greater than 0.1 cm/minute. In other embodiments, the substrate continuously advances through the steps of the above methods at a rate greater than 0.05 cm/minute. In sill other embodiments, the substrate continuously advances through the steps of the above methods at a rate greater than 0.01 cm/minute. In still other embodiments, the substrate is cycled through the deposition, forming, separating and collecting steps more than 10 times 50 times, more than 1,000 time or more than 100,000 times.

In some embodiments, the substrate is wider than about 1 cm. In other embodiments, the substrate has a length greater than 1 m, 10 m, 100 m, 1,000 m or 10,000 m. In some of these embodiments, the substrate is a metal foil.

In some embodiments, carbon nanotubes are formed on all sides of the substrate. In other embodiments, carbon nanotubes are formed on both sides of the metal foil.

In some embodiments, the concentration of catalyst deposited on the substrate is between about 0.001% and about 25%. In other embodiments, the concentration of catalyst deposited on the substrate is between about 0.1% and about 1%. In still other embodiments, the concentration of catalyst deposited on the substrate is between about 0.5% and about 20%.

In some embodiments, the concentration of carbon nanotube on the substrate is between about 1 nanotube per μM and about 50 nanotubes per μM. In other embodiments, the concentration of carbon nanotube on the substrate is between about 10 nanotubes per μM and about 500 nanotubes per μM.

In some embodiments, the CNTs are separated from the substrate by mechanical removal of the CNTs from the surface of the substrate. In other embodiments, separation of CNTs from the substrate involves removing the CNTs from the surface of the substrate with a mechanical tool (e.g., a blade, an abrasive surface, etc.) thus yielding high purity CNTs with little or no metal impurities, which do not require any additional purification. In still other embodiments, separation of CNTs from the substrate involves chemical methods that disrupt adhesion of CNTs to the substrate. In yet other embodiments, ultrasonication disrupts adhesion of CNTs to the substrate. In still other embodiments, pressurized gas flow disrupts adhesion of CNTs to the substrate. The combination of depositing CNTs on a substrate and separating CNTs from the substrate renders CNT products of uniform length free of catalyst and amorphous carbon impurities.

The CNTs can be collected in or on any convenient object, such as for example, an open vessel, a wire mesh screen, a solid surface, a filtration device, etc. The choice of collection device will be correlated with the method used to disrupt adhesion of CNTs to the substrate.

In some embodiments, the carbon nanotubes are randomly aligned. In other embodiments, the carbon nanotubes are vertically aligned. In still other embodiments, the uniform length is on average about 30 μM, 50 μM, about 100 μM, about 150 μM or about 200 μM. In still other embodiments, the uniform length can range from 50 μM to 2 cm. In general, the uniform length is about +/− 10% of the stated length. Accordingly, a sample with a uniform length of about 100 μM will include nanotubes of length between 90 μM and 110 μM. In still other embodiments, carbon nanotubes are vertically aligned and are of uniform length.

In some embodiments, the density of the carbon nanotubes is between about 2 mg/cm2 and about 1 mg/cm2. In other embodiments, the density of the carbon nanotubes between about 2 mg/cm2 and about 0.2 mg/cm2.

In some embodiments, vertically aligned carbon nanotubes have a thermal conductivity of greater than about 50 W/mK. In other embodiments, vertically aligned carbon nanotubes have a thermal conductivity of greater than about 70 W/mK.

In some embodiments, the thickness of the vertically aligned carbon nanotubes is between than about 100 μm and about 500 μm. In other embodiments, the thickness of the vertically aligned carbon nanotubes is less than about 100 μm.

In some embodiments, the carbon nanotubes are of greater than about 90%, about 95%, about 99%, about 99.5% or about 99.9% purity. In other embodiments, the carbon nanotubes are of greater than about 90%, about 95%, about 99%, about 99.5% or about 99.9% purity and are of uniform length of about10 μM, about 20 μM, about 30 μM, about 50 μM, about 100 μM, about 150 μM or about 200 μM. In still other embodiments, the carbon nanotubes are vertically aligned, of greater than about 90%, about 95%, about 99%, about 99.5% or about 99.9% purity and are of uniform length of about 30 μM, about 50 μM, about 100 μM, about 150 μM or about 200 μM. It should be noted that the above embodiments explicitly cover all possible combinations of purity and length.

In some embodiments, the tensile strength of the carbon nanotubes is between about 11 GPa and about 63 GPa. In other embodiments, the tensile strength of the carbon nanotubes is between about 20 GPa and about 63 GPa. In still other embodiments, the tensile strength of the carbon nanotubes is between about 30 GPa and about 63 GPa. In still other embodiments, the tensile strength of the carbon nanotubes is between about 40 GPa and about 63 GPa. In still other embodiments, the tensile strength of the carbon nanotubes is between about 50 GPa and about 63 GPa. In still other embodiments, the tensile strength of the carbon nanotubes is between about 20 GPa and about 45 GPa.

In some embodiments, the elastic modulus of the carbon nanotubes is between about 1.3 TPa and about 5 TPa. In other embodiments, the elastic modulus of the carbon nanotubes is between about 1.7 TPa and about 2.5 TPa. In still other embodiments, the elastic modulus of the carbon nanotubes is between about 2.7 TPa and about 3.8 TPa.

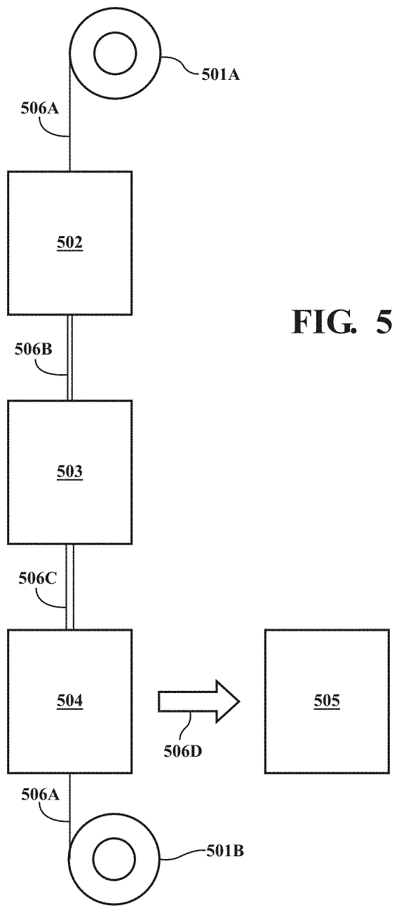

Referring now to FIG. 5, a device for continuously synthesizing CNTs is provided. Transport module includes drums 501A and 501B, which are connected by substrate 506. Substrate 506 continuously moves from drum 501A through catalyst module 502, nanotube synthesis module 503 and separation module 504 to drum 501B. Note that naïve substrate 506A, is modified by catalyst module 502 to provide substrate 506B which contains catalyst. In some embodiments, catalyst module 502 is a solution of catalyst in which substrate 506A is immersed. Carbon nanotubes are continuously formed on substrate 506B during transit through nanotube synthesis module 503 to yield substrate 506C, which includes carbon nanotubes. In some embodiments, nanotube synthesis module 503 is a CVD chamber. Substrate 506C is continuously processed by separation module 504 and stripped of attached carbon nanotubes to yield substrate 506A, which is then collected by drum 501B. In some embodiments, separation module 504 includes a blade which mechanically shears the newly formed CNTs from substrate 506C. Note that carbon nanotubes removed from substrate 506C are continuously collected by process 506D at collection module 505. In some embodiments, collection module 505 is simply an empty vessel situated appropriately to collect the CNTs separated from the substrate surface by separation module 504. In the above embodiment, substrate 506 is not recycled during the production run.

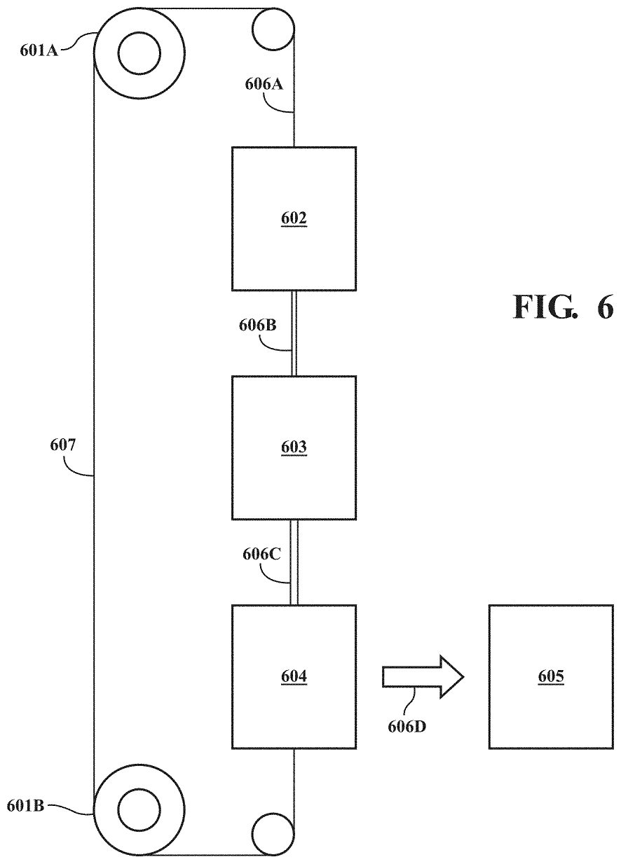

Referring now to FIG. 6, another device for continuously synthesizing CNTs is schematically illustrated. Transport module includes drums 601A and 601B, which are connected by substrate 606. Substrate 606 continuously moves from drum 601A through catalyst module 602, nanotube synthesis module 603 and separation module 604 to drum 601B. Note that naïve substrate 606A, is modified by catalyst module 602 to provide substrate 606B which contains catalyst. In some embodiments, catalyst module 502 is a solution of catalyst in which substrate 606A is immersed. Carbon nanotubes are continuously formed on substrate 606B during transit through nanotube synthesis module 603 to yield substrate 506C. In some embodiments, nanotube synthesis module 603 is a CVD chamber. Substrate 606C is continuously processed by separation module 604 and stripped of attached carbon nanotubes to yield substrate 606A, which is then collected by drum 601B. In some embodiments, separation module 604 includes a blade which mechanically shears the newly formed CNTs from substrate 606C. Note that carbon nanotubes removed from substrate 606C are continuously collected by process 606D at collection module 605. In some embodiments, collection module 605 is simply an empty vessel situated appropriately to collect the CNTs separated from the substrate surface by separation module 604. In the above embodiment, the substrate is recycled through the production run at least once.

Although many of the above embodiments have been described as synthesizing nanotubes continuously, those of skill in the art will appreciate that the methods and devices described herein may be practiced discontinuously.

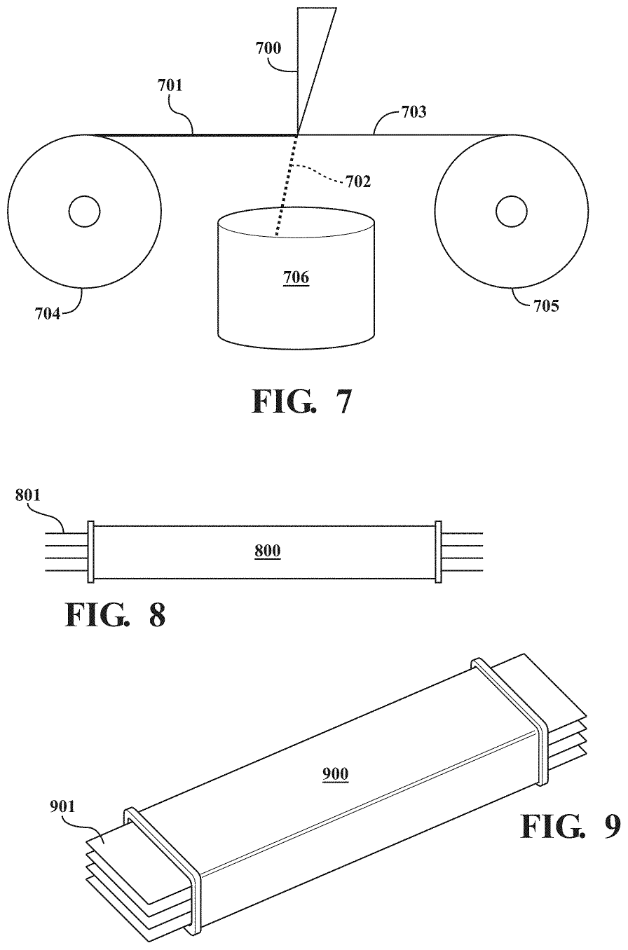

FIG. 7 schematically illustrates an exemplary separation module. Drum 704 advances substrate 701, which has been processed by catalyst module (not shown) and carbon nanotube deposition module (not shown) and which is covered with carbon nanotubes to tool 700, which removes carbon nanotubes 702 to provide substrate 703 devoid of carbon nanotubes. In some embodiments, tool 700 is a cutting blade. The substrate 703 is collected by drum 705. Carbon nanotubes 702 are collected in container 706. Substrate 701, as illustrated, is coated on only one side with carbon nanotubes. Those of skill in the art will appreciate that nanotubes can be grown on both sides of the substrate and that a substrate with both sides coated can be processed in a manner analogous to that described above.

FIG. 8 illustrates a horizontal view of an exemplary rectangular quartz chamber 800, which may be used in the nanotube synthesis module that includes multiple substrates 801, which contain catalyst. FIG. 9 illustrates a perspective view of an exemplary rectangular quartz chamber 900, which may be used in the nanotube synthesis module that includes multiple substrates 901, which contain catalyst. The quartz chamber includes shower heads (not shown) for carrier gases and carbon feedstocks and may be heated at temperatures sufficient to form CNTs. In some embodiment, the chamber has inner chamber thickness of greater than 0.2 inch. In other embodiments, more than substrate is processed by the chamber simultaneously.

CNTs can be characterized by a multitude of techniques, including, for example, Raman, spectroscopy, UV, visible, near infrared spectroscopy, florescence and X-ray photoelectron spectroscopy, thermogravimetric analysis, atomic force microscopy, scanning tunneling, microcopy, scanning electron microscopy and tunneling electron microscopy. A combination of many, if not all of the above are sufficient to fully characterize carbon nanotubes.

In some embodiments, the CNTs have an I_{d}/I_{g} ratio of less than about 1.20. In other embodiments, the CNTs have an I_{d}/I_{g} ratio of less than about 1.10. In still other embodiments, the CNTs have an I_{d}/I_{g} ratio of less than about 1.00. In still other embodiments, the CNTs have an I_{d}/I_{g} ratio of less than about 0.90. In still other embodiments, the CNTs have an I_{d}/I_{g} ratio of less than about 0.85. In still other embodiments, the graphene nanoribbons have an I_{d}/I_{g} ratio between about 0.76 and about 0.54.

In some embodiments, the CNTs have an I_{d}/I_{g} ratio of less than about 1.20 and greater than about 0.76. In other embodiments, the CNTs have an I_{d}/I_{g} ratio of less than about 1.10 and greater than about 0.76. In still other embodiments, the CNTs have an I_{d}/I_{g} ratio of less than about 1.00 and greater than about 0.76. In still other embodiments, the CNTs have an I_{d}/I_{g} ratio of less than about 0.90 and greater than about 0.76. In still other embodiments, the CNTs have an I_{d}/I_{g} ratio of less than about 0.85 and greater than about 0.76.

The inflection point is the temperature at which thermal degradation reaches its maximum value. The onset point is the temperature at which about 10% of the material degrades owing to high temperature. In some embodiments, the CNTs have an inflection point greater than about 700° C. and an onset point of greater than about 600° C. In some embodiments, the CNTs have an inflection point greater than about 710° C. and an onset point of greater than about 610° C. In some embodiments, the CNTs have an inflection point greater than about 720° C. and on onset point of greater than about 620° C. In some embodiments, the CNTs have an inflection point greater than about 730° C. and an onset point of greater than about 640° C. In some embodiments, the CNTs have an inflection point greater than about 740° C. and an onset point of greater than about 650° C. In some of the above embodiments, the onset point is less than about 800° C.

In general, graphene nanoribbons can be prepared from CNTs by methods which include but are not limited to acid oxidation (e.g., Kosynkin et al., Nature, 2009, 458, 872; Higginbotham et al., ACS Nano, 210, 4, 2596; Cataldo et al., Carbon, 2010, 48, 2596; Kang et al., J. Mater. Chem., 2012, 22, 16283; and Dhakate et al., Carbon 2011, 49, 4170), plasma etching (e.g., Jiao et al., Nature, 2009, 458, 877; Mohammadi et al., Carbon, 2013, 52, 451; and Jiao et al., Nano Res 2010, 3, 387), ionic intercalation, (e.g., Cano-Marques et al., Nano Lett. 2010, 10, 366), metal particle catalysis (e.g., Elias et al., Nano Lett. Nano Lett., 2010, 10, 366; and Parashar et al., Nanaoscale, 2011, 3, 3876), hydrogenation (Talyzin et al., ACS Nano, 2011, 5, 5132) and sonochemistry (Xie et al., J. Am. Chem. Soc. 2011, DOI: 10.1021/ja203860). Any of the above methods may be used to prepare graphene nanoribbons from the CNTs described herein. Referring now to FIG. 14 a SEM image illustrates the high purity and structural homogeneity of the GNRs produced by the methods described herein. The linearity of GNRs prepared in the above fashion is also indicative of structural homogeneity and superior physical properties for his class of materials.

In some embodiments, the uniform length of the graphene nanoribbons is on average about10 μM, about 20 μM, about 30 μM, about 50 μM, about 100 μM, about 150 μM or about 200 μM. In other embodiments, the uniform length can range from about 30 μM to about 2 cm. In general, the uniform length is about +/− 10% of the stated length. Accordingly, a sample with a uniform length of about 100 μM will include GNRs of length between about 90 μM and about 110 μM.

In some embodiments, the graphene nanoribbons are made from carbon nanotubes of uniform length of which is on average about10 μM, about 20 μM, about 30 μM, about 50 μM, about 100 μM, about 150 μM or about 200 μM.

In some embodiments, the graphene nanoribbons are of greater than about 90%, about 95%, about 99%, about 99.5% or about 99.9% purity. In other embodiments, graphene nanoribbons are of greater than about 90%, about 95%, 99%, about 99.5% or about 99.9% purity and are of uniform length of about 10 μM, about 20 μM, about 30 μM about 50 μM, about 100 μM, about 150 μM or about 200 μM. In still other embodiments the graphene nanoribbons are of uniform length of about 10 μM, about 20 μM, about 30 μM about 50 μM, about 100 μM, about 150 μM or about 200 μM and of greater than 99% purity. In still other embodiments the graphene nanoribbons are of uniform length of about 20 μM, and of greater than 99% purity. It should be noted that the above embodiments explicitly cover all possible combinations of purity and length.

In some embodiments, the graphene nanoribbons have an I_{2d}/I_{g} ratio of less than about 1.20. In other embodiments, the graphene nanoribbons have an I_{2d}/I_{g} ratio of less than about 1.10. In still other embodiments, the graphene nanoribbons have an I_{2d}/I_{g} ratio of less than about 1.20. In still other embodiments, the graphene nanoribbons have an I_{2d}/I_{g} ratio of less than about 1.00. In still other embodiments, the graphene nanoribbons have an I_{2d}/I_{g} ratio of less than about 0.90. In still other embodiments, the graphene nanoribbons have an I_{2d}/I_{g} ratio of less than about 0.80. In still other embodiments, the graphene nanoribbons have an I_{2d}/I_{g} ratio of less than about 0.70. In still other embodiments, the graphene nanoribbons have an I_{2d}/I_{g} ratio of less than about 0.60. In still other embodiments, the graphene nanoribbons have an I_{2d}/I_{g} ratio between about 0.60 and about 0.54. In still other embodiments, the graphene nanoribbons have an I_{2d}/I_{g} ratio between about 0.54 and about 0.1.

In some embodiments, the graphene nanoribbons have an I_{2d}/I_{g} ratio of less than about 1.20 and greater than about 0.60. In other embodiments, the graphene nanoribbons have an I_{2d}/I_{g} ratio less than about 1.10 and greater than about 0.60. In still other embodiments, the graphene nanoribbons have an I_{2d}/I_{g ratio} of less than about 1.00 and greater than about 0.60. In still other embodiments, the graphene nanoribbons have an I_{2d}/I_{g ratio} of less than about 0.90 and greater than about 0.60. In still other embodiments, the graphene nanoribbons have an I_{2d}/I_{g ratio} of less than about 0.85 and greater than about 0.60.

In some embodiments, the GNRs have an inflection point greater than about 700° C. and an onset point of greater than about 600° C. In some embodiments, the GNRs have an inflection point greater than about 710° C. and an onset point of greater than about 610° C. In some embodiments, the GNRs have an inflection point greater than about 720° C. and on onset point of greater than about 620° C. In some embodiments, the GNRs have an inflection point greater than about 730° C. and an onset point of greater than about 640° C. In some embodiments, the GNRs have an inflection point greater than about 740° C. and an onset point of greater than about 650° C. In some of the above embodiments, the onset point is less than about 800° C.

Provided herein are graphene electrodes which may be used in a variety of energy storage devices, such as, for example, lithium-ion batteries, lithium-ion polymer batteries, solid state batteries or ultracapacitors. In some embodiments, the electrode includes graphene nanoribbons of uniform length and greater than about 90% purity. In other embodiments, the electrode includes graphene nanoribbons of uniform length and greater than about 95% purity. In still other embodiments, the electrode includes graphene nanoribbons of uniform length and greater than about 99% purity. In still other embodiments, the electrode includes graphene nanoribbons of uniform length and greater than about 99.5% purity. In still other embodiments, the electrode includes graphene nanoribbon of uniform length and greater than about 99.9% purity.

In some of the above embodiments, the length of the graphene nanoribbons is about 20 i.t.M. In other of the above embodiments, the length of the graphene nanoribbons is about 50 μM. In still other of the above embodiments, the length of the graphene nanoribbons is about 100 μM. In still other of the above embodiments, the length of the graphene nanoribbons is about 200 μM. In still other embodiments the electrode includes graphene nanoribbons of uniform length of about 10 μM, about 20 μM, about 30 μM about 50 μM, about 100 μM, about 150 μM or about 200 μM and of greater than 99% purity. In still other embodiments the electrode includes graphene nanoribbons of uniform length of about 20 μM, and of greater than 99% purity.

In some of the above embodiments, the electrodes may also include a cathode active material. Cathode active materials include, but are not limited to, lithium cobalt oxide, lithium nickel oxide, lithium manganese oxide, lithium vanadium oxide, lithium-mixed metal oxide, lithium iron phosphate, lithium manganese phosphate, lithium manganese cobalt, lithium vanadium phosphate, lithium mixed metal phosphates, metal sulfides, nickel manganese cobalt and combinations thereof. The cathode active material may also include chalcogen compounds, such as, for example, titanium disulfate or molybdenum disulfate, or combinations thereof. In some implementations, the cathode material is lithium cobalt oxide (e.g., LiₓCoO₂ where 0.8≤x≤1), lithium nickel oxide (e.g., LiNiO₂) or lithium manganese oxide (e.g., LiMn₂O₄ and LiMnO₂), lithium iron phosphate or combinations thereof.

Cathode materials can be prepared in the form of a fine powder, nanowire, nanorod, nanofiber, or nanotube. In some embodiments, the cathode active material is lithium cobalt oxide, nickel manganese cobalt, nickel cobalt aluminum oxide, lithium nickel manganese cobalt, lithium nickel cobalt aluminum oxide, lithium manganese oxide, lithium iron phosphate or Fe₂S. Any known cathode active materials can be employed in the energy storage devices described herein.

In some of the above embodiments, the electrode may also include an anode active material. Anode active materials include, but are not limited to, lithium metal, carbon, lithium-intercalated carbon, lithium nitrides, lithium alloys with silicon, bismuth, boron, gallium, indium, zinc, tin, tin oxide, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide or combinations thereof. In some embodiments, the anode active material is graphite, lithium titanate, tin/cobalt alloy, silicon or solid-state lithium. Any known anode active materials can be employed in the energy storage devices described herein.

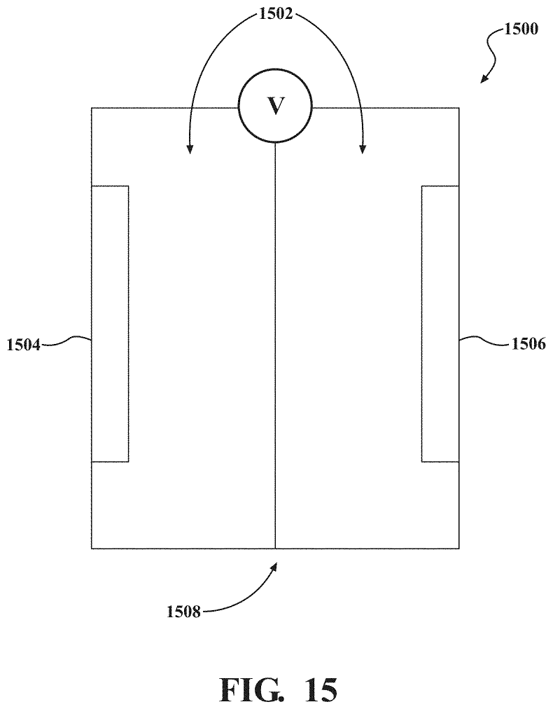

Also provided herein is an electrochemical cell including one or two electrodes described in some of the above embodiments. An electrochemical cell is illustrated in FIG. 15. Referring now to FIG. 15, an electrochemical cell 1500 has at least one electrode which includes graphene nanoribbons of uniform length and greater than about 90% purity. In some embodiments the electrode includes graphene nanoribbons of uniform length of about 10 μM, about 20 μM, about 30 μM about 50 μM, about 100 μM, about 150 μM or about 200 μM and of greater than 99% purity. In other embodiments the electrode includes graphene nanoribbons of uniform length of about 20 μM, and of greater than 99% purity. Anode 1506 and cathode 1504 are immersed in liquid electrolyte 1502 and isolated by separator 1508 to provide electrochemical cell 1500.

Also provided herein is a lithium-ion battery. The lithium-ion battery has a housing which includes one or two electrodes described in some of the above embodiments, a liquid electrolyte disposed between an anode and a cathode and a separator between the cathode and anode.

An exemplary cell of a lithium-ion battery is also illustrated in FIG. 15. In a lithium-ion battery, the liquid electrolyte 1502 must include a lithium salt. At least one electrode includes graphene nanoribbons of uniform length and greater than about 90% purity. In some embodiments the electrode includes graphene nanoribbons of uniform length of about 10 μM, about 20 μM, about 30 μM about 50 μM, about 100 μM, about 150 μM or about 200 μM and of greater than 99% purity.

Also provided herein is a lithium-ion polymer battery. The lithium-ion polymer battery has a housing which includes one or two electrodes described in some of the above embodiments, a polymer electrolyte disposed between an anode and a cathode and a microporous separator between the cathode and anode. In some embodiments, the polymer electrolyte is a gelled polymer electrolyte. In other embodiments, the polymer electrolyte is a solid polymer electrolyte.

A cell of a lithium-ion polymer battery is also illustrated by FIG. 15. Referring now to FIG. 15, the electrolyte 1502 is lithium-ion polymer and the separator 1508 is a microporous separator. At least one electrode includes graphene nanoribbons of uniform length and greater than about 90% purity. In some embodiments the electrode includes graphene nanoribbons of uniform length of about 10 about 20 about 30 μM about 50 about 100 about 150 μM or about 200 μM and of greater than 99% purity.

Also provided herein is a solid-state battery. The solid-state battery has a housing which including one or two electrodes described in some of the above embodiments and a solid electrolyte layer disposed between an anode and a cathode. At least one electrode includes graphene nanoribbons of uniform length and greater than about 90% purity. In some embodiments the electrode includes graphene nanoribbons of uniform length of about 10 about 20 about 30 μM about 50 about 100 about 150 μM or about 200 μM and of greater than 99% purity.

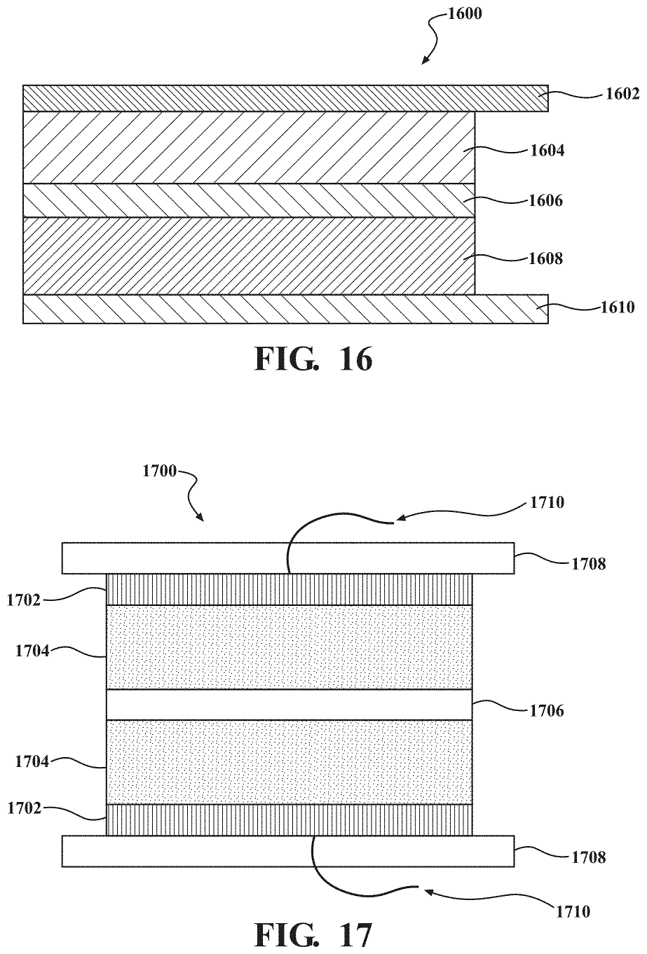

A solid-state battery is illustrated in FIG. 16. Referring now to FIG. 16, solid state battery is configured in layered form and included a positive electrode layer 1604 a negative electrode layer 1608 and a solid-state electrolyte layer 1606 between the electrode layers. At least one electrode includes graphene nanoribbons of uniform length and greater than about 90% purity. In some embodiments the electrode includes graphene nanoribbons of uniform length of about 10 about 20 about 30 μM about 50 about 100 about 150 μM or about 200 μM and of greater than 99% purity. Also shown are positive electrode current collector 1602 and negative current collector 1610.

Also provided herein is an ultracapacitor. The ultracapacitor has a power source attached to two collectors where at least one of the collectors is in contact with one or two electrodes described in some of the above embodiments, a liquid electrolyte disposed between the electrodes and a separator between the current electrodes. In some embodiments, the ultracapacitor is a pseudo-capacitor.

A block diagram of an exemplary ultracapacitor is illustrated in FIG. 17. Referring now to FIG. 17, ultracapacitor 1700 has two electrodes 1704 separated by an electrolytic membrane 7106. At least one electrode includes graphene nanoribbons of uniform length and greater than about 90% purity. In some embodiments the electrode includes graphene nanoribbons of uniform length of about 10 about 20 about 30 μM about 50 about 100 about 150 μM or about 200 μM and of greater than 99% purity.

Electrical leads 1710 (e.g., thin metal wires) contact collectors 1702 to make electrical contact. Ultracapacitor 1700 is submerged in an electrolyte solution and leads 1710 are fed out of the solution to facilitate capacitor operation. Clamp assembly 1708 (e.g., coin cells or laminated cells) holds carbon nanotubes 1704 attached to metal substrate 1702 in close proximity while membrane 1706 maintain electrode separation (i.e., electrical isolation) and minimizes the volume of ultracapacitor 1700. Ultracapacitor 1700 consists of electrodes 1704 attached to collectors 1702 and an electrolytic membrane 1706 which are immersed in a conventional aqueous electrolyte (e.g., 45% sulfuric acid or KOH).

in some embodiments, the ultracapacitor is a pseudo-capacitor. In some of these embodiments, electrodes are loaded with oxide particles (e.g., RuO₂, MnO₂, Fe₃O₄, NiO₂, MgO₂, etc.). in other of these embodiments, electrodes are coated with electrically conducting polymers polypyrrole, polyaniline, polythiophene, etc.). in some embodiments, the ultra.capacnor is an asymmetric capacitor (i.e., one electrode is different from the other electrode in the capacitor).

In some of the above embodiments of energy storage devices, the number of electrodes is one and the electrode is the anode. In other of the above embodiments, the number of electrodes is one and the electrode is the cathode. In still other of the above embodiments, the number of electrodes is two and one electrode are the anode and the second electrode is the cathode.

In some of the above embodiments, the anode further comprises an anode active material. In other of the above embodiments, the cathode further comprises a cathode active material. In still other of the above embodiments, the anode further comprises an anode active material and the cathode further comprises a cathode active material. In some of the above embodiments, the cathode active material is lithium cobalt oxide, nickel manganese cobalt, nickel cobalt aluminum oxide, lithium nickel manganese cobalt, lithium nickel cobalt aluminum oxide lithium manganese oxide, lithium iron phosphate or Fe₂S and the anode active material is graphite, lithium titanate, tin/cobalt alloy, silicon or solid-state lithium.

Other conductive additives, which may be used in the electrodes described herein, include but are not limited to, carbon particulates, graphite, carbon black, carbon nanotubes, graphene nanosheets, metal fibers, acetylene black, and ultra-fine graphite particles or combinations thereof. In general, any conductive materials with suitable properties may be used in the energy storage devices described herein.

Binders which may be used in the electrodes described herein include poly(vinyl)acetate, polyvinyl alcohol, polyethylene oxide, polyvinyl pyrrolidone, alkylated polyethylene oxide, cross-linked polyethylene oxide, polyvinyl ether, poly(methyl methacrylate), polyvinylidene fluoride, polyvinyl fluoride, polyimides, polytetrafluoroethylene, ethylene tetrafluoroethylene (ETFE), polyhexafluoropropylene, copolymer(product name: Kynar) of polyvinylidene fluoride, poly(ethyl acrylate), polytetrafluoroethylenepolyvinylchloride, polyacrylonitrile, polyvinylpyridine, polystyrene, carboxy methyl cellulose, siloxane-based binders such as polydimethylsiloxane, rubber-based binders comprising styrene-butadiene rubber, acrylonitrile-butadiene rubber, and styrene-isoprene rubber, ethyleneglycol-based binders such as polyethylene glycol diacrylate and derivatives thereof, blends thereof, and copolymers thereof. More specific examples of the copolymer of polyvinylidene fluoride include polyvinylidene fluoride-hexafluoropropylene copolymers, polyvinylidene fluoride-tetrafluoroethylene copolymers, polyvinylidene fluoride-chlorotrifluoroethylene copolymers, and polyvinylidene fluoride-hexafluoropropylene-tetrafluoroethylene copolymers. In general, any binders with suitable properties may be used in the energy storage devices described herein.

The separator is any membrane which transports ions. In some embodiments, the separator is a liquid impermeable membrane which transports ion. In other embodiments, the separator is a porous polymer membrane infused with liquid electrolyte that shuttles ions between the cathode and anode materials, while preventing electron transfer. In still other embodiments, the separator is a microporous membrane, which prevents particles comprising the positive and negative electrodes from crossing the membrane. In still other embodiments, the separator is a single or multilayer microporous separator, which fuses above a certain temperature to prevent ion transfer. In still other implementations, the separator includes polyethyleneoxide (PEO) polymer in which lithium salt is complexed, Nafion, Celgard, Celgard 3400, glass fibers or cellulose. In still other embodiments, the microporous separator is porous polyethylene or polypropylene membrane. Any known separator which has been used in lithium-ion batteries can be employed in the energy storage devices described herein.

Electrolytes include aqueous electrolytes (e.g., sodium sulfate, magnesium sulfate, potassium chloride, sulfuric acid, magnesium chloride, etc.), organic solvents (e.g., 1-ethyl-3-methylimidazolium bis(pentafluoroethylsulfonyl)imide, etc.), electrolyte salts soluble in organic solvents, tetralkylammonium salts (e.g., (C₂H₅)₄NBF₄, (C₂H₅)₃CH₃NBF₄, (C₄H₉)₄NBF₄, (C₂H₅)₄NPF₆, etc.), tetralkylphosphonium salts (e.g. (C₂H₅)₄PBF₄, (C₃H₇)₄PBF₄, (C₄H₉₁₄PBF₄, etc.), lithium salts (;e.g., LiPF₄, LiPF₆, LiCF₃SO₃, LiClO₄, etc., N-alkyl-pyridinium salts, 1,3 bisalkyl imidazolium salts, etc.), etc. Lithium salts such as, for example, LIPF₆, LiBF₄, LICF₃SO₃. LiClO₄ are typically dissolved in an organic solvent such ethylene carbonate, dimethyl carbonate, diethyl carbonate, methyl ethyl carbonate, ethyl propionate, methyl propionate, propylene carbonate, γ-butyrolactone, acetonitrile, ethyl acetate, propyl formate, methyl formate, toluene, xylene, methyl acetate or combinations thereof. Any known electrolyte and/or solvent which has been used with ultracapacitors and electrochemical cells may be used with the ultracapacitor, and electrochemical cell energy storage devices described herein. Any known non-aqueous solvent or any known electrolyte which have been used in lithium-ion batteries can be employed in the lithium-ion energy storage devices described herein.

Also useful are polymer electrolytes such as gel polymer electrolytes and solid polymer electrolytes. Gel polymer electrolytes are derived from mixing poly(ethylene oxide) (PEO), poly(vinylidene difluoride), polyvinyl chloride, poly(methyl methacrylate) and poly(vinylidene fluoride-hexafluoropropylene) copolymer) with a liquid electrolyte. Solid polymer electrolytes include polyethylene oxides, polycarbonates, polysiloxanes, polyesters, polyamines, polyalcohols, fluorpolyiners, liginin, chitin and cellulose. Any known gel polymer electrolyte or any known solid state polymer electrolyte which have been used in lithium-ion batteries can be employed in the energy storage devices described herein.

Solid state electrolytes used in solid state batteries include inorganic solid electrolytes, (e.g., sulfide solid state electrolyte materials (i.e., Li₂S—P₂S, and LiS—P₂S₅—LiI), oxide solid state electrolyte materials, nitride solid state electrolyte materials, and halide solid state electrolyte materials.) and solid polymer electrolytes, (e.g., polyethylene oxides, polycarbonates, polysiloxanes, polyesters, polyarnines, polyalcohols, liginin, chitin and cellulose) Other examples include NASICON-type oxides, garnet type oxides and perovskite-type oxides. Any solid-state electrolyte which has been used in lithium-ion batteries can be employed in the energy storage devices described herein.

The anode layer in solid-state batteries can include lithium transition metal oxides such as lithium titanate, transition metal oxides such as TiO₂, Nb₂O₃ and WO₃, metal sulfides, metal nitrides, carbon materials such as graphite, soft carbon and hard carbon, metallic lithium metallic indium, lithium alloys and the like along with other anode materials referenced above.

The cathode layer in solid-state batteries can include lithium cobaltate (LiCoO₂), lithium nickelate (LiNiO₂), LiNiₚMn_{q}CoᵣO₂(p+q+r=1), LiNiₚAl_{q}CoᵣO₂(p+q+r=1), Li₁₊ₓMn_{2-x-y}MyO₄(x+y=2), M is at least on of Al, Mg, Co, Fe, Ni, and Zn and lithium metal phosphate LiMnPO₄, m is at least one of Fe, Mn, Co and Ni along with conventional cathode material referenced above.

Current collectors include metals such as Al, Cu, Ni, Ti, stainless steel and carbonaceous materials.

Without wishing to be bound by theory, uniform dispersion of graphene nanoribbons of uniform length and greater than about 90% purity with active materials (i.e., both cathode and anode active materials) may be important for best electrode performance. Graphene nanoribbons, which are uniformly dispersed in active materials may make electrical connections with active particles in either the cathode and anode which may improve conductivity and lower resistance while increasing capacity and charge rates. More extensive physical contact between the graphene nanoribbons and active particles in either the cathode or anode may form a better electrical network in the electrode layers which may result in lower sheet resistance.

In some embodiments, the weight percentage of graphene nanoribbons to active material (i.e., both cathode and anode active materials) is about 5%. In other embodiments, the weight percentage of graphene nanoribbons to active material (i.e., both cathode and anode active materials) is about 2.5%. In some embodiments, the weight percentage of graphene nanoribbons to active material (i.e., both cathode and anode active materials) is about 1%. In some embodiments, the weight percentage of graphene nanoribbons to active material (i.e., both cathode and anode active materials) is about 0.5%.

### Representative Embodiments

1. An electrode comprising graphene nanoribbons of uniform length and greater than about 90% purity.

2. The electrode of embodiment 1, wherein the graphene nanoribbons are of greater than about 95% purity.

The electrode of embodiment 1, wherein the graphene nanoribbons are of greater than about 99% purity.

The electrode of embodiment 1, wherein the graphene nanoribbons are of greater than about 99.5% purity.

The electrode of embodiment 1, wherein the graphene nanoribbons are of greater than about 99.9% purity.

The electrode of embodiments 1-5, wherein the length of the graphene nanoribbons is about 20 μM.

The electrode of embodiments 1-5, wherein the length of the graphene nanoribbons is about 50 μM.

The electrode of embodiments 1-5, wherein the length of the graphene nanoribbons is about 100 μM.

The electrode of embodiments 1-5, wherein the length of the graphene nanoribbons is about 200 μM.

The electrode of embodiments 1-9 further comprising a cathode active material.

The electrode of embodiment 10, wherein the cathode active material is lithium cobalt oxide, nickel manganese cobalt, nickel cobalt aluminum oxide, lithium nickel manganese cobalt, lithium nickel cobalt aluminum oxide lithium manganese oxide, lithium iron phosphate or Fe2S.

The electrode of embodiments 1-9 further comprising an anode active material.

The electrode of embodiment 12, wherein the anode active material is graphite, lithium titanate, tin/cobalt alloy, silicon or solid-state lithium.

An electrochemical cell comprising one or two electrodes of embodiments 1-9.

The electrochemical cell of embodiment 14, wherein the number of electrodes is one and the electrode is the anode.

The electrochemical cell of embodiment 14, wherein the number of electrodes is one and the electrode is the cathode.

The electrochemical cell of embodiment 14, wherein the number of electrodes is two and one electrode are the anode and the second electrode is the cathode.

The electrochemical cell of embodiment 15, wherein the anode further comprises an anode active material.

The electrochemical cell of embodiment 16, wherein the cathode further comprises a cathode active material.

The electrochemical cell of embodiment 17, wherein the anode further comprises an anode active material and the cathode further comprises a cathode active material.

The electrochemical cell of embodiment 17, wherein the cathode active material is lithium cobalt oxide, nickel manganese cobalt, nickel cobalt aluminum oxide, lithium nickel manganese cobalt, lithium nickel cobalt aluminum oxide lithium manganese oxide, lithium iron phosphate or Fe₂S and the anode active material is graphite, lithium titanate, tin/cobalt alloy, silicon or solid-state lithium.

A lithium-ion battery comprising a housing including one or two electrodes of embodiments 1-9; a liquid electrolyte disposed between an anode and a cathode; and a separator between the cathode and anode.

A lithium-ion polymer battery comprising a housing including one or two electrodes of embodiments 1-9; a polymer electrolyte disposed between the anode and cathode; and a microporous separator.

The lithium-ion polymer battery of embodiment 23, wherein the polymer electrolyte is a gelled polymer electrolyte.

The lithium-ion polymer battery of embodiment 23, wherein the polymer electrolyte is a solid polymer electrolyte.

A solid-state battery comprising a housing including one or two electrodes of embodiments 1-9; and a solid electrolyte layer disposed between an anode layer and a cathode layer.

An ultracapacitor comprising: a power source attached to two collectors wherein at least one of the collectors are in contact with one or two electrodes of embodiments 1-9; a liquid electrolyte disposed between the electrodes; and a separator between the current electrodes.

The ultracapacitor of embodiment 26, wherein the ultracapacitor is a pseudo-capacitor.

Finally, it should be noted that there are alternative ways of implementing the present invention. Accordingly, the present embodiments are to be considered as illustrative and not restrictive, and the invention is not to be limited to the details given herein but may be modified within the scope and equivalents of the appended claims.

All publications and patents cited herein are incorporated by reference in their entirety.

The following examples are provided for illustrative purposes only and are not intended to limit the scope of the invention.

### EXAMPLES

### Example 1

### Thermogravimetric Analysis of Multiwalled CNTs

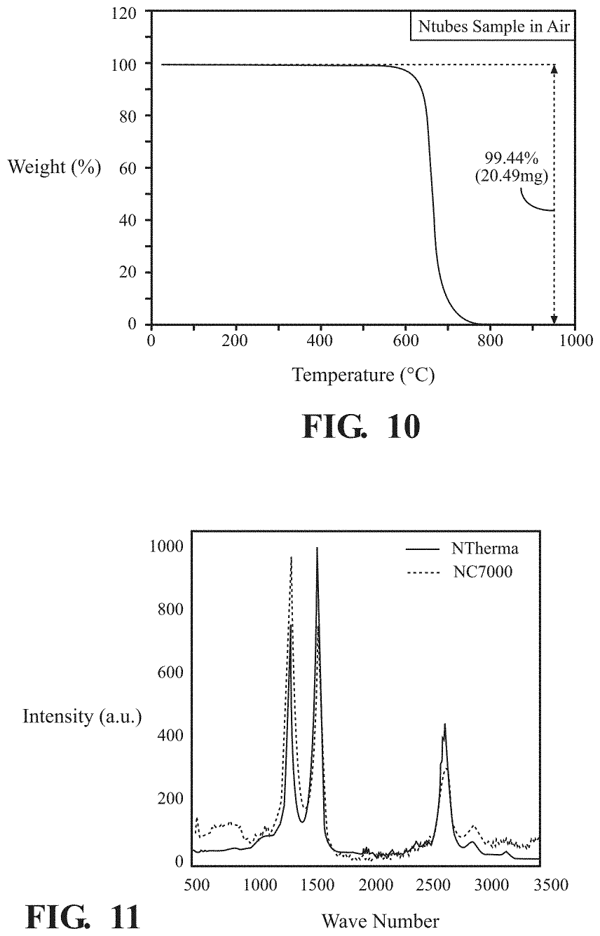

The carbon purity and thermal stability of CNTs were evaluated using a Thermogravimetric Analyzer (TGA), TA instruments, Q500. The samples were heated under air atmosphere (Praxair AI NDK) from temperature to 900° C. at a rate of 10° C/min and held at 900° C. for 10 minutes before cooling. Carbon purity is defined as (weight of all carbonaceous material)/(weight of all carbonaceous materials+weight of catalyst). FIG. 10 illustrates thermal stability data for multi-walled carbon nanotubes made by the methods and devices described herein. The multi-walled carbon nanotubes made herein have an inside diameter of about 5 nm with between 5-8 walls with a customizable length of between 10 μM and 200 μM. In the region below 400° C. is where amorphous carbon and carbonaceous materials with poor thermal resistance were degraded. As can be seen from the graph there is almost no amorphous carbon and carbonaceous materials in the multi-walled carbon nanotubes made by the methods and devices described herein. The carbon purity of the CNTs made by the methods and devices described herein is greater than 99.3% while in contrast, in a commercially available CNT (not shown) the carbon purity is 99.4%.

### Example 2

### Raman Analysis of Multiwalled CNTs

10 mg of CNTs were suspended in about 100 mL of methanol to form a blackish solution. The resulting suspension was then sonicated for about 10 minutes to uniformly disperse CNTs in the suspension since a thin layer of CNTs is required for Raman spectra. The suspension was then spread over Si substrate to form a thin layer. The coated Si substrate was then placed in an oven for 10 minutes at 130° C. to vaporize the dispersing agent from the sample. Raman spectra were then recorded with a Thermos Nicolet Dispersive XR Raman Microscope with a laser radiation of 532 nm, integration of 50 s, 10× objective and a laser of 24 mW. The ratio of D and G band intensities is often used as a diagnostic tool to verify the structural perfection of CNTs.

FIG. 11 illustrates Raman spectra of multi-walled carbon nanotubes made by the methods and devices described herein (solid line) and commercially available CNTs (dashed line). The I_{D}/I_{G} and the I_{G}/I_{G}′ ratio of the multi-walled carbon nanotubes made by the methods and devices described herein are 0.76 and 0.44 respectively, while the same ratios for commercially available CNTs are 1.27 and 0.4, respectively. The above demonstrates, the greater crystallinity of the multi-walled carbon nanotubes made by the methods and devices described herein over those produced by other methods and is in accord with the thermal stability data.

### Example 3

### Thermogravimetric Analysis of Multiwalled GNRs

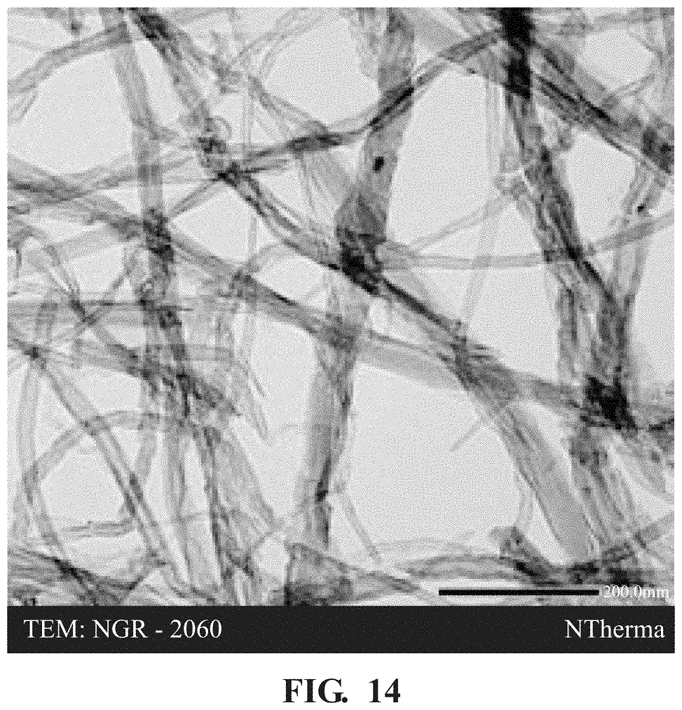

The carbon purity and thermal stability of CNTs were evaluated using a Thermogravimetric Analyzer (TGA), TA instruments, Q500. The samples were heated under air atmosphere (Praxair AI NDK) from temperature to 900° C. at a rate of 10° C./min and held at 900° C. for 10 minutes before cooling. Carbon purity is defined as (weight of all carbonaceous material)/(weight of all carbonaceous materials+weight of catalyst). FIG. 13 illustrates thermal stability data for GNRs made by the methods described herein. The GNRs made have a customizable length of between 10 μM and 200 μM. In the region below 400° C. is where amorphous carbon and carbonaceous materials with poor thermal resistance were degraded. As can be seen from the graph there is almost no amorphous carbon and carbonaceous materials in the GNRs made by the methods and devices described herein. The carbon purity is greater than 99.2%.

### Example 4

### Raman Analysis of GNRs

10 mg of CNTs were suspended in about 100 mL of methanol to form a blackish solution. The resulting suspension was then sonicated for about 10 minutes to uniformly disperse CNTs in the suspension since a thin layer of CNTs is required for Raman spectra. The suspension was then spread over Si substrate to form a thin layer. The coated Si substrate was then placed in an oven for 10 minutes at 130° C. to vaporize the dispersing agent from the sample. Raman spectra, as illustrated in Fig. were then recorded with a Thermos Nicolet Dispersive XR Raman Microscope with a laser radiation of 532 nm, integration of 50 s, 10X objective and a laser of 24 mW. The ratio of D and G band intensities is often used as a diagnostic tool to verify the structural perfection of CNTs.

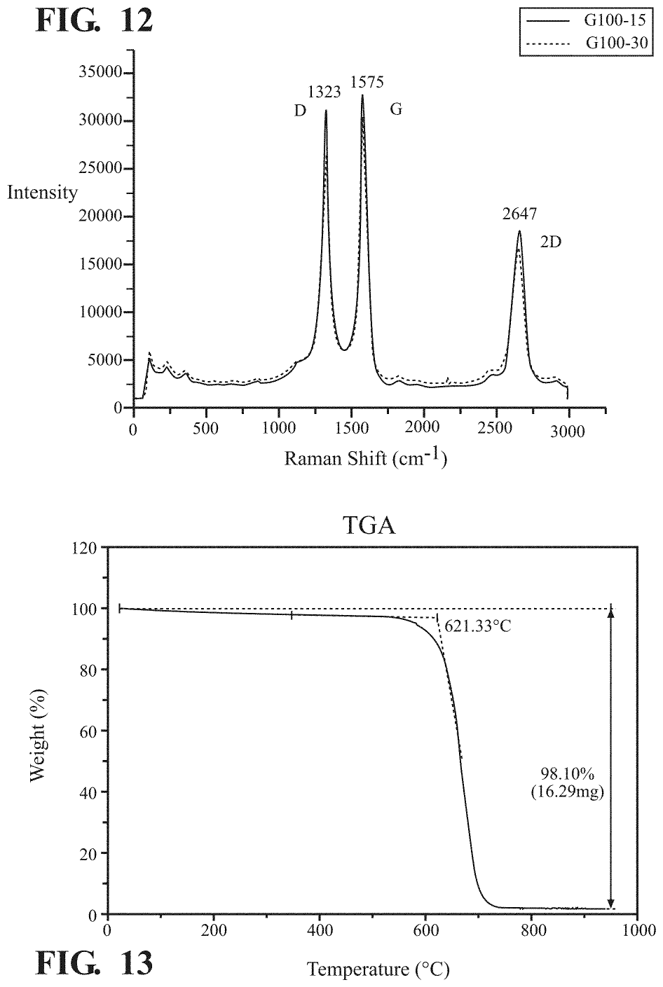

FIG. 12 illustrates Raman spectra of GNRs made by the methods described herein (solid line). The I_{2D}/I_{G} and I_{D}/I_{G} of the GNRs made by the methods described herein are 0.6 and 0.75 respectively, which demonstrates the standard graphene signature and illustrates minimal defects from the chemical unzipping process.

### Example 5

### Preparation of Solution Dispersions of Graphene Nanoribbons

1.0 g of GNRs are added to a plastic or glass bottle followed by 99.0 g of solvent (e.g., water, N-methyl pyrrolidone, dimethyl formamide, dimethyl acetic acid, etc.) to from a liquid dispersion and the bottle is tightly sealed. The bottle is shaken and placed in a ultrasonicator and sonicated for 30-60 minutes. The above is repeated so that the total time of sonication is about 3 hours. After sonication is completed, a viscous paste has formed in the bottle. The contents of the bottle should be shaken vigorously prior to mixing with any electrode material.

### Example 6

### Comparison of SEM images of CNTs Prepared in Fluidized Bed Reactors and the Methods and Devices Described in This Application

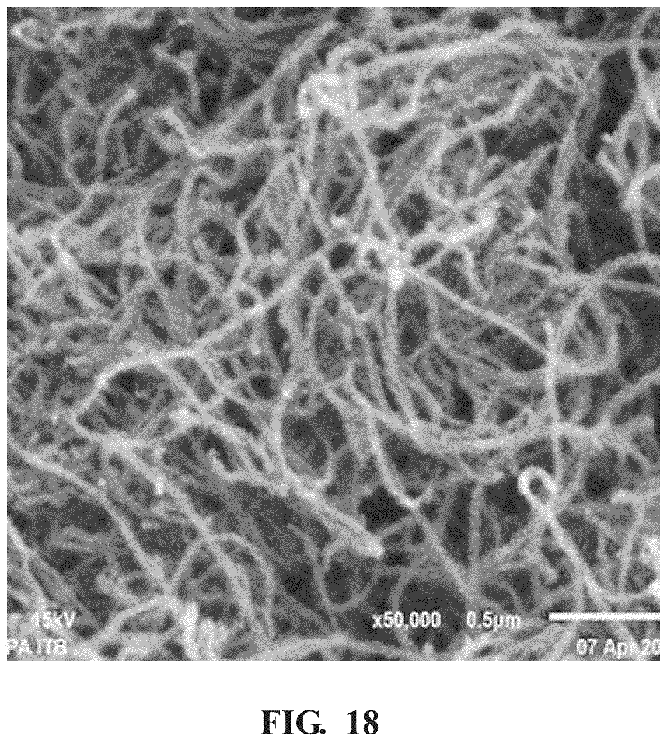

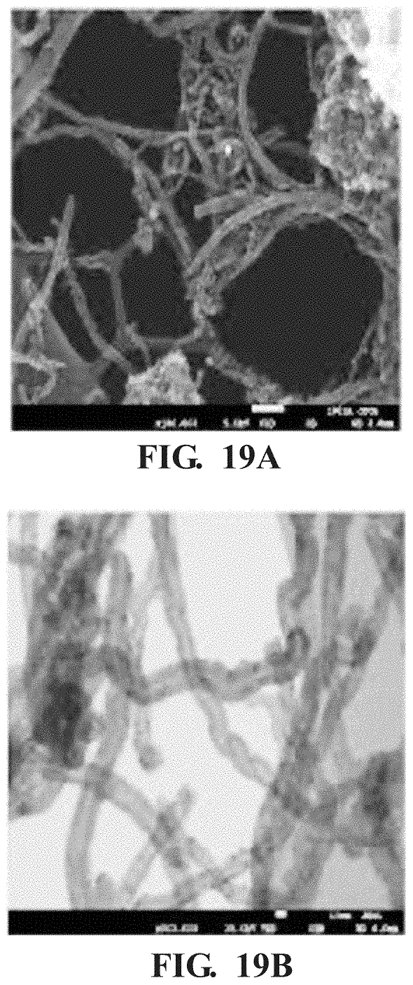

Standard procedures for scanning electron microscopy (“SEM”) were used to acquire the images shown in FIGS. 18, 19A and 19B. The SEM image in FIG. 18 illustrates the defects of CNTs prepared by a standard fluidized bed reactor procedure. The lack of linearity in the CNTs shown in FIG. 18 is indicative of defective sites that have carbon atoms which are not arranged in a C6 ring structure. CNTs prepared by the methods and procedures described herein are illustrated in FIGS. 19A and 19B. Notably, FIGS. 19A and 19B show the CNTs prepared by the methods and procedures described herein are more linear structures with less defective sites. Accordingly, the CNTs prepared by the methods and procedures described herein have superior electrical and thermal conductivity and mechanical strength than CNT prepared by standard procedures.

### Example 7

### Electrode Manufacturing

Powders containing the active electrode material (e.g., lithium, nickel, composites, etc.) are mixed with dispersions of GNRs as prepared in Example 4 and binding materials to form an electrode slurry. The slurry is spread on foil which is passed through a heat source maintained at temperatures up to 150° C. to form a solid electrode coating. The roll is cut into smaller pieces which are then stamped by a die to provide individual battery electrode segments. The individual electrode segments are wrapped in insulating layers and are amalgamated to form electrode stacks by conventional methods. The electrode stacks are then inserted into a moisture resistant barrier material obtained by conventional methods to form a pouch cell which is then injected with an electrolyte solution. The electrolyte saturated pouch cell is then sealed by application of heat and vacuum.

### Example 8

### Comparison of SEM images of a Slurry of Si Particles (20 %) with Graphite Anode with a Slurry of Nickel Manganese Cobalt Cathode Particles Which Include 0.5% GNRs and a Slurry of Nickel Manganese Cobalt Anode Particles Which Include 1.5% GNRs

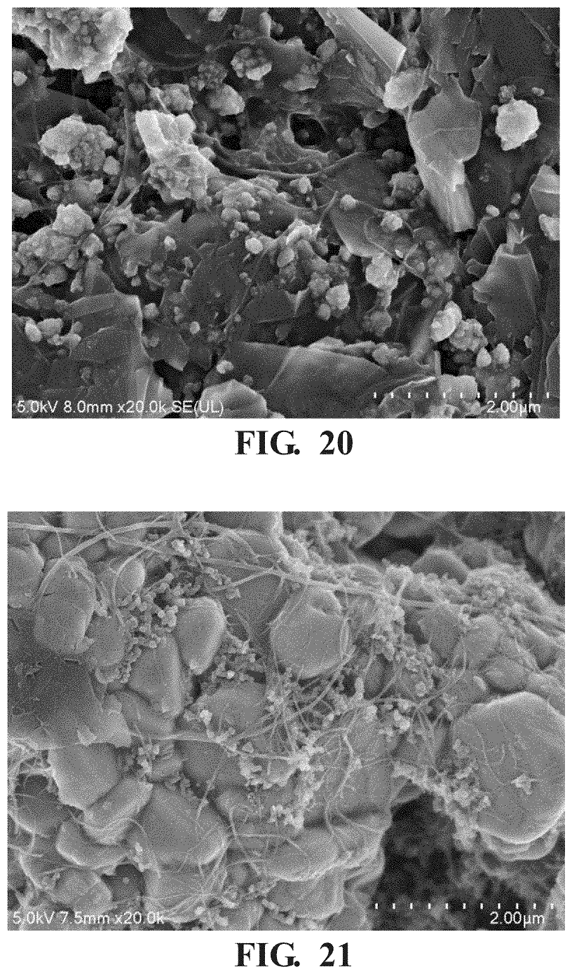

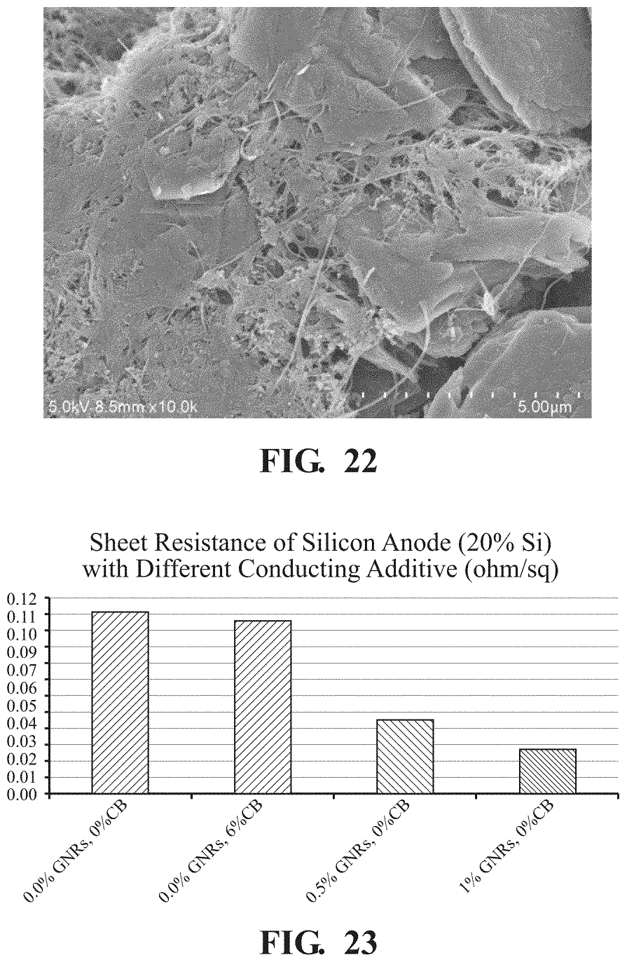

The electrode slurries with active particles were prepared as described in Example 7. Standard procedures for scanning electron microscopy (“SEM”) were used to acquire the images shown in FIGS. 20, 21 and 22. As can be seen in FIG. 20, little electrical connectivity can be seen between the Si particles (20%) in the slurry by SEM. In contrast, in FIGS. 21 and 22, extensive connectivity mediated by GNRs (20 μM length, and >99% purity) can be observed between nickel manganese cobalt cathode particles in the slurry which include either 0.5% GNRs (FIG. 21) and 1.5% GNRs (FIG. 22). Thus, GNR additives may assist in forming a uniform electrical network of active electrode particles which allows for high electronic diffusion and enhance the ability of these active particles to store ions in the cathode and anode.

### Example 9

### Improved Electronic Conductivity of the Slurries of Active Particles in the Electrode Layer Mediated by GNR Additives

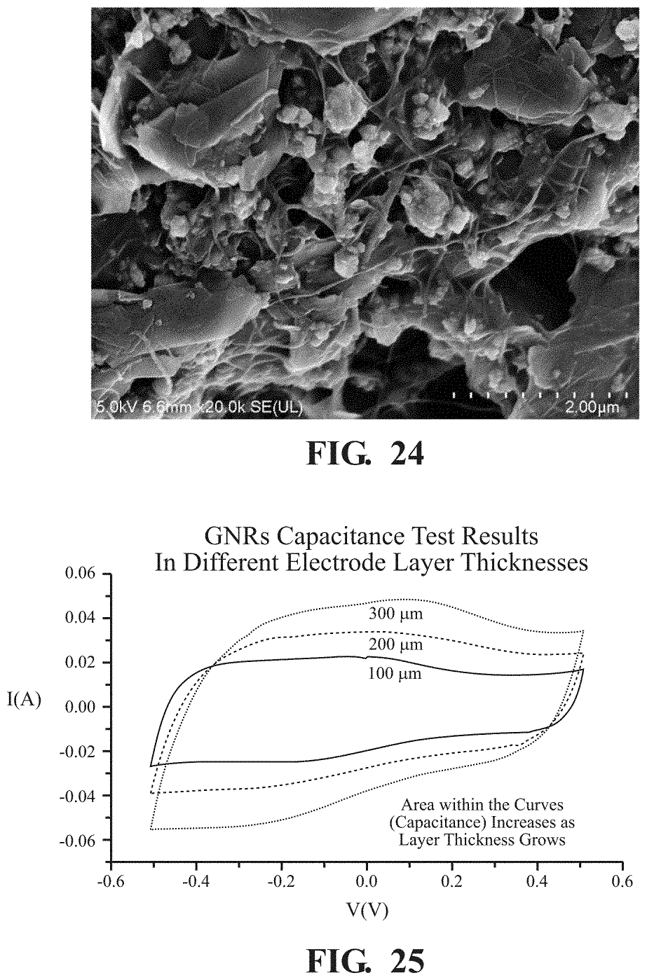

The electrode slurries with active particles were prepared as described in Example 7. Standard procedures for scanning electron microscopy (“SEM”) were used to acquire the images shown in FIG. 24. As illustrated in FIG. 24, extensive connectivity mediated by GNRs (20 μM length, and >99% purity) can be observed between Si anode particles (20%) in the slurry which includes 0.5% GNRs.

The effect of this connectivity on electrode conductivity was then studied by measurement of the sheet resistance by the 4-point probe method which uses sharp needles as probes on a thin electrode layer. A four-point probe consists of four electrical probes in a line, with equal spacing between each of the probes and operates by applying a current (I) on the outer two probes and measuring the resultant voltage drop between the inner two probes. A DC current is forced between the outer two probes, and a voltmeter measures the voltage difference between the inner two probes. The resistivity is calculated from geometric factors, the source current, and the voltage measurement. Along with a four-point collinear probe, the instrumentation used for this test includes a DC current source and a sensitive voltmeter. An integrated parameter analyzer featuring multiple source measure units along with control software can be used for a wide range of material resistances including very high-resistance semiconductor materials.

The measurement of sheet resistance of a silicon anode (20% Si) with different conducting additives is shown in FIG. 23 was conducted as described above. The sheet resistance of a silicon anode (20% Si) with either no additive or 5% carbon black is above about 0.10 ohm/sq in FIG. 23. In contrast, the sheet resistance of a silicon anode (20% Si) with 0.5% GNR or 1.0 GNR additive is less than 0.05 ohm/sq or 0.04 ohm/sq, respectively. The greater surface contact between the GNRs and the active electrode particles demonstrated by the SEM images in FIG. 24 results in lower sheet resistance, thus improving the electrical conductivity of the electrode.

### Example 10

### Pouch Cell Cycling with Cathodes with GNR Additives

Cycle life testing was performed as follows. The cathode pouch cell, prepared as described in Example 7, was fully charged at 30° C. over a three-hour period (C/3). Then the cell was fully discharged at 30° C. over a three-hour period. These steps were repeated for 100 cycles with recording of every discharge capacity. The capacity retention ratio was calculated by the discharge capacity at each cycle divided by the capacity in step 2. Data for six cells with nickel manganese cobalt cathode which include 1.0% GNRs (20 μM length, and >99% purity) and a graphite anode were compared with data for 5 cells with nickel manganese cobalt cathode particles and a graphite anode with carbon black are show in Table 1.

TABLE 1

| Nickel manganese cobalt cathode | | | | Nickel manganese cobalt cathode | | |
|---|---|---|---|---|---|---|
| particles and a graphite anode | | | | particles which include 1.0% | | |
| with carbon black | | | | GNRs and a graphite anode | | |
| Cycle # | 1 | 50 | 100 | 1 | 50 | 100 |
| Mean- | 101.2 | 100.4 | 96.8 | 120.6 | 111.3 | 107.5 |
| Capacity | | | | | | |
| (mAh) | | | | | | |
| St. Dev. | 17.43 | 9.76 | 11.32 | 12.1 | 9.3 | 9.7 |
| Capacity | | | | | | |
| (mAh) | | | | | | |

| | | | |
|---|---|---|---|
| Capacity Improvement (%) | 19.2% | 10.9% | 11.1% |

As shown above significant improvement in capacity was observed when the nickel manganese cobalt cathode included 1.0% GNRs (20 μM length, and >99% purity).

### Example 11

### Pouch Cell Cycling with Anodes with GNR Additives

Cycle life testing was performed as follows. The anode pouch cell prepared as described in Example 7 was fully charged at 30° C. over a three-hour period (C/3). Then the cell was fully discharged at 30° C. over a three-hour period. These steps were repeated for 100 cycles with recording of every discharge capacity. The capacity retention ratio was calculated by the discharge capacity at each cycle divided by the capacity in step 2. Data for six cells with nickel manganese cobalt cathode particles and a graphite anode which include 1.0% GNRs (20 μM length, and >99% purity) and six cells with nickel manganese cobalt cathode and a graphite anode which include 0.5% GNRs (20 μM length, and >99% purity) were compared with data for 5 cells with nickel manganese cobalt cathode and a graphite anode with carbon black are shown in Table 3

TABLE 2

| Nickel manganese cobalt | | | | Nickel manganese cobalt | | | Nickel manganese cobalt | | |
|---|---|---|---|---|---|---|---|---|---|
| cathode particles and a | | | | cathode particles and a | | | cathode particles and a | | |
| graphite anode with | | | | graphite anode which | | | graphite anode which | | |
| carbon black | | | | include 0.5% GNRs | | | include 1.0% GNRs | | |
| Cycle # | 1 | 50 | 100 | 1 | 50 | 100 | 1 | 50 | 100 |
| Mean- | 101.2 | 100.4 | 96.8 | 128.2 | 120.0 | 116.6 | 133.7 | 120.5 | 117.5 |
| Capacity | | | | | | | | | |
| (mAh) | | | | | | | | | |
| St. Dev. | 15.4 | 9.8 | 11.3 | 7.9 | 5.4 | 4.9 | 8.2 | 7.5 | 7.5 |
| Capacity | | | | | | | | | |
| (mAh) | | | | | | | | | |

| | | | | | | |
|---|---|---|---|---|---|---|
| Capacity Improvement (%) | 26.7 | 19.5 | 20.5 | 32.1 | 20.0 | 21.7 |

As shown above, significant improvement in capacity was observed when the graphite anode included 0.5% (20 μM length, and >99% purity) or 1.0% GNRs (20 μM length, and >99% purity).

### Example 12

### Optimization of Super Capacitors with GNR Additives

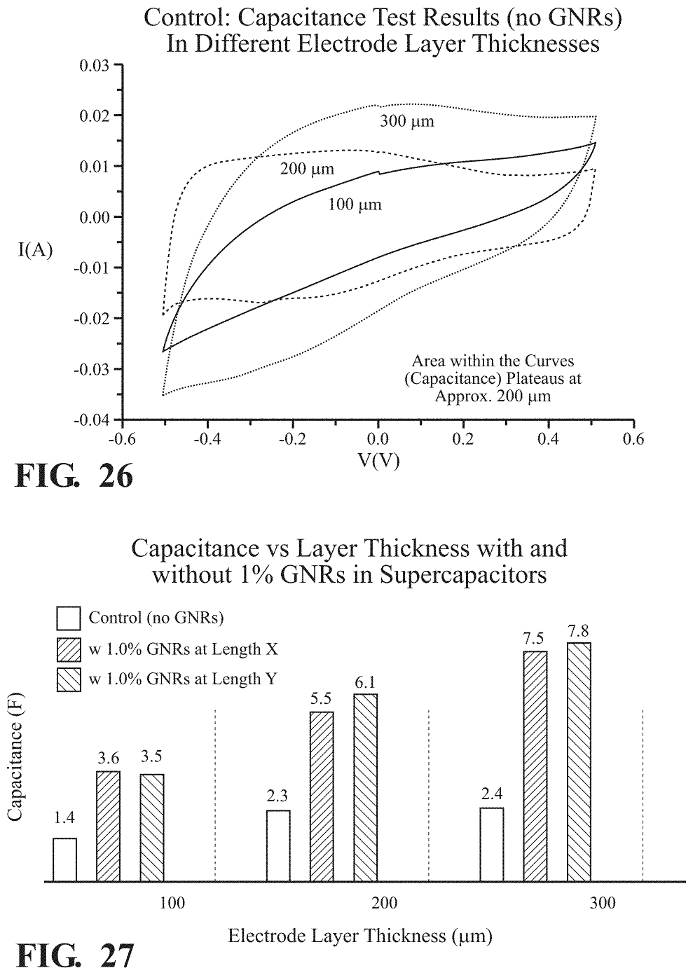

Supercapacitors were made by conventional means. FIG. 25 illustrates the capacitance results when one of the carbon black electrodes of the supercapacitor includes 1.0% GNRs (20 μM length, and >99% purity). The area with the curve (i.e., capacitance) increases as the electrode layer thickness is increased when 1.0% GNRs are included as shown in FIG. 26. In contrast, when GNRs are not included in the electrode, the area within the curve (i.e., capacitance) plateaus at about 200 μm as shown in FIG. 26. The relationship between capacitance, electrode layer thickness and the presence or absence of GNRs in the electrode are summarized in FIG. 27. The results above demonstrate that the addition of 1% GNRs to a carbon black electrode in a supercapacitor leads to a three-fold increase in capacitance per cm². These results may enable higher energy density with fewer metal layers per capacitor and thicker electrode layers with higher capacitance per layer.

1. An electrode comprising graphene nanoribbons of uniform length and greater than about 90% purity.

2. The electrode of claim 1, wherein the graphene nanoribbons are of greater than about 99% purity.

3. The electrode of claim 1, wherein the length of the graphene nanoribbons is about 20 μM.

4. The electrode of claim 1 further comprising a cathode active material.

5. The electrode of claim 3, wherein the cathode active material is lithium cobalt oxide, nickel manganese cobalt, nickel cobalt aluminum oxide, lithium nickel manganese cobalt, lithium nickel cobalt aluminum oxide lithium manganese oxide, lithium iron phosphate or Fe₂S.

6. The electrode of claim 1 further comprising an anode active material.

7. The electrode of claim 5, wherein the anode active material is graphite, lithium titanate, tin/cobalt alloy, silicon or solid-state lithium.

8. An electrochemical cell comprising one or two electrodes of claim 1.

9. The electrochemical cell of claim 7, wherein the number of electrodes is one and the electrode is the anode.

10. The electrochemical cell of claim 8, wherein the number of electrodes is one and the electrode is the cathode

11. The electrochemical cell of claim 7, wherein the number of electrodes is two and one electrode is the anode and the second electrode is the cathode.

12. The electrochemical cell of claim 9, wherein the anode further comprises an anode active material.

13. The electrochemical cell of claim 9, wherein the cathode further comprises a cathode active material.

14. The electrochemical cell of claim 10, wherein the anode further comprises an anode active material and the cathode further comprises a cathode active material.

15. A lithium-ion battery comprising a housing including one or two electrodes of claim 1;
a liquid electrolyte disposed between an anode and a cathode; and
a separator between the cathode and anode.

16. A lithium-ion polymer battery comprising a housing including one or two electrodes of claim 1;
a polymer electrolyte disposed between the anode and cathode; and
a microporous separator.

17. A solid-state battery comprising a housing including one or two electrodes of claim 1; and
a solid electrolyte layer disposed between an anode layer and a cathode layer.

18. An ultracapacitor comprising:
a power source attached to two collectors wherein at least one of the collectors are in contact with one or two electrodes of claim 1;
a liquid electrolyte disposed between the electrodes; and
a separator between the current electrodes.
